(19) United States
(12) Patent Application Publication
(10) Pub. No.: US 2018/0225139 A1
(43) Pub. Date: Aug. 9, 2018

(54) LOAD AND SOFTWARE CONFIGURATION CONTROL AMONG COMPOSITE SERVICE FUNCTION CHAINS

(71) Applicant: NOKIA SOLUTIONS AND NETWORKS OY, ESPOO (FI)

(72) Inventors: WOLFGANG HAHN, BERGFELDE (DE); BORISLAVA GAJIC, UNTERHACHING (DE)

(21) Appl. No.: 15/750,313

(22) PCT Filed: Aug. 3, 2015
(86) PCT No.: PCT/EP2015/067832

§ 371 Date: Feb. 5, 2018

(51) Int. Cl. G06F 9/455; G06F 9/50

(52) U.S. Cl. CPC G06F 9/45558; G06F 2009/4557; G06F 9/5077

(57) ABSTRACT

A method, an apparatus and a computer program product are related to service function chain management. Management functionality is directed to efficient controlling software configuration for service function chains and to adaptively invoke, reconfigure or stop virtual machines for load balancing purposes to cope with the dynamic life traffic.

### FIELD OF THE INVENTION

The present invention relates to a method, an apparatus and a computer program product related to service function chain management. More particularly, the present invention relates to a method, an apparatus and a computer program product related to load and software configuration control of service function chains.

### BACKGROUND OF THE INVENTION

A mean to reduce operator network TCO is network functions virtualization and using common Data Center (DC) hardware for different network functions (see documents of ETSI NFV (Network Function Virtualization study group)).

This applies for service function chaining, too. Service Function Chaining typically observe, alter or even terminate and re-establish session flows between user equipment and application platforms (Web, Video, VoIP etc.) by invoking, in a given order, a set of Service Functions. Service functions involved in a given service function chain (SFC, sometimes denoted as “chain” hereinafter) may include load-balancing, firewalling, intrusion prevention, etc.

A given SFC-enabled domain may involve several instances of the same Service Function. Service function instances can be added to or removed from a given SFC. SFs can be co-located or embedded in distinct physical nodes, or virtualized.

Today, mobile network operators are providing numerous value adding packet processing functions in the so called “Gi-LAN” (such as NAT, TCP optimizers, firewalls, video optimizers). They may be considered as SFCs, wherein the SFCs are implemented by chains of boxes the traffic needs to be routed through. Inefficiency of those solutions and complexity to manage this have resulted in standardization activities in 3GPP Rel.13 (Flexible mobile service steering FMSS) and IETF (SFC, Service Function Chaining).

E.g. in most cases of the network functions (security, NAT, load balancing, etc.) only a fraction of a flow requires processing by all functions while the remaining part of the flow requires limited or other processing. By flexible flow routing the amount of required resources can be decreased.

A next level of network flexibility is expected to be introduced with 5 G. Research projects are being setup to introduce tailored network functions depending on the offered end to end service (e.g. 5 G NORMA).The idea is to decompose current network functions of the RAN and core and to select service specific both
a flavor of the decomposed functions (e.g. different scheduling algorithms depending on the service); and
a location (more centralized or more at the mobile edge).

This increases the need to efficiently compose and connect network services from a high number of elementary functional modules. Note that the technologies used and introduced here are independent of any access technology.

In general, it is aimed to implement those service functions (SF) most effectively and efficiently in the cloud. Current approaches (see below) just virtualize the former physical “box-functions” to become VNF (Virtual Network Functions) and use the connectivity framework provided by the data center (DC) to create the required data path.

But routing all user plane traffic through a DC is very challenging, see ETSI NFV INF005 documents:

“The dataplane throughput is a general concern for the NFV architecture [. . . ]. The throughput capacity of a virtualised network function deployment on an NFVI Node is a fundamental consideration as it is for network elements implementing physical network functions.”

Typical SFs in a SF chain are applications that involve some static and relatively small CPU code but have high requirements on throughput and/or on low latency. In terms of network function infrastructure (NFVI) this means limited computing requirements but high networking requirements.

Currently this problem is addressed by accelerating the data path processing of connectivity/networking in the cloud environment—today typically carried out by virtual switches.

There are approaches that certain OS functions (socket API and vNIC) are extended or that new, direct interfaces between networking and application function are introduced (e.g. using Intel's DPDK and or SR-IOV to bypass the host and/or guest OS for fast packet transfer).

Although by these measures the networking performance between virtual machines (VMs) that host the service functions can be accelerated—still a number of problems remain:
additional latency is introduced by each VM-VM communication;
there is some unpredictability how big this delay is: this may depend on the topology, e.g. VM residing on the same blade, rack etc, and using different acceleration mechanisms;
need to scale and load-balance each individual SF (The problem arises from the fact that scaling in DC is usually implemented by increasing (scale out) or decreasing (scale in) the number of VMs used to run a specific network function;
complex resource allocation and scheduling of VM/SF instantiation due to the high number of VMs and restrictions that need to be taken into account (delay budget, throughput) by the VIM and networking controller.

It may also be considered whether additional features that should turn an “IT-DC” (a general purpose DC such as a DC for Web Servers) into a “Telco cloud DC” (a DC dedicated for telecommunication services) will increase the cost and destroys the economy of scale if complexity is added that is not needed for the typical work load of an IT-DC. Thus, new measures to improve the Telco cloud DC services might increase the complexity of virtualization.

FIG. 1 shows an arrangement as proposed in the prior art.

In the data plane (bottom part), a router (shown by a box marked by “X”), routes traffic to one of plural SFCs (in FIG. 1, an upper SFC (chain 1) and a lower SFC (chain 2) are shown) based on a classifier (e.g. an UL classifier) controlled by a control entity (e.g. PCRF). In each of the SFCs, several SFs (in FIG. 1: SF1 to SF4) and load balancers are chained. Some SFs (e.g. SF1 and SF2 in FIG. 1) may be used in plural SFCs. The entities, in particular those responsible for forwarding the traffic from one SF to another SF of a chain, in the SFCs may be controlled by e.g. SDN control. Each of the instances of the SFs and LBs, the classifiers, and the control entities may be realized by a separate VM. In some implementations, the one or more classifiers may be integrated with router “X” or with a load balancer. In some implementations, one or more classifiers may be implemented by dedicated hardware.

That is, by virtualized computing and networking, the rigid Gi-LAN can be replaced with Service Chaining, a software framework based on virtualized appliances (or simply VNFs) connected by virtualized networking, automated and managed by a service chain orchestrator using VNF and cloud management APIs.

FIG. 2 (taken from IETF: Service Function Chaining (SFC) Control Plane Architecture, draft-ww-sfc-control-plane-04, retrieved from https://datatracker.ietf.org/doc/draft-ww-sfc-control-plane/) shows a SFC architecture. SFC Control plane is responsible for constructing SFC, translating SFCs to forwarding paths and propagating path information to participating nodes to achieve requisite forwarding behavior and construct the service overlay. Traffic that enters a SFC-enabled domain is classified according to the rules the SFC Control Plane provides to the Classifier. After classification, the traffic is forwarded into the SFC-enabled domain passing a set of Service Functions as defined in the corresponding SFC instructions. SFC-specific forwarding information is used by Service Forwarder Entity (i.e., a node which include service forwarder function (SFF)) to make traffic forwarding decisions and pass the traffic to the next Service Function instance within the chain, through the Service Function Path derived from Control Plane Information and instantiated from the Classifier. For further details, it is referred to the cited IETF document.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In particular we use the concept of a virtual machine (VM) for describing the state of the art computing environment for software in data centres. The VM relates to a software appliance (application SW and operating system) running on top of a hypervisor providing the virtualization of physical computing resources. The reference to VM shall not exclude other virtualization environments like so called containers where the software applications can share also parts of the operating system or a combination of hypervisor based and container based virtualization.

The concepts we propose here as well as the prior art arrangement (FIG. 1) may even work without any virtualization. This means the service functions of a SFC are running directly on physical processors (CPU) that can be arranged in a pool of CPUs in server blades. In this case the terms VM and processor/CPU need to be exchanged: instead of the load of the VM the load of the CPU needs to be measured etc.

In summary the term VM is used only as an example on how to execute a service function or a complete SFC.

According to a first embodiment of the invention, there is provided a method for adaptive service function chain configuration, wherein a multitude of virtual machines are executed on a given hardware, and a single instance of a virtual machine is executing a complete service function chain, said service function chain comprising a multitude of service functions, the method comprising the steps of continuously measuring the processing load of each virtual machine which is executing a specific service function chain and in case that the processing load of a certain virtual machine exceeds a predefined load level, an additional virtual machine that is able to execute the specific service function chain will be activated to execute the specific service function chain while in case that the processing load of a certain virtual machine underruns a predefined load level, the work load of the specific service function chain of said virtual machine is transferred to another virtual machine that is able to execute the service function chain and in consequence the specific service function chain of said virtual machine is deactivated.

A variant of the above described embodiment of the invention could be a method that a virtual machine, which service function chain execution has been deactivated to any reasons, e.g. due to extremely low work load, can be used to take over the functionality of another virtual machine and execute service functions of another virtual machine which exceeds a predefined load level.

It may be another embodiment of the invention for load and software control among composite service function chains where necessary software components, which are needed to run a certain service chain functionality are loaded into all virtual machines. This enables the system, that any possible subset of service chains may be executed on those virtual machines without prior loading software components into this virtual machine.

Activation or deactivation of service function chains in virtual machines is controlled by a so-called resource manager. The resource manager is implemented by control and management entities, especially the Element Management System EMS.

There may also be embodiments, where only a subset of software components is loaded into a virtual machine. The loaded subset of software components however must be sufficient to execute one or several service chain functionalities.

The functionality that will be activated in any instance of a virtual machine during runtime has to be defined by a so-called service function chain descriptor. The descriptor defines what service functions constitute the SFC and in what topology they are arranged.

Another important aspect is that the system is able to react flexibly to the permanently changing load situation. Therefore means should be provided which enable the system to measure the processing load of any virtual machine. This can be achieved in different ways. One possibility is, that the virtual machine which is executing a service function chain itself comprises means for measuring the processing load. Another possible solution is, that the underlying infrastructure (HW or the operating system) provides means to measure the processing load of a virtual machine and this information is transferred to an infrastructure manager and the service function chain resource manager on a regular basis.

In an other embodiment the processing load is defined by relevant parameters like processor load, memory space, free or unused memory space and/or combination of this plus any other parameters that are suitable for load measuring.

Of course, the different embodiments described above will run on a hardware apparatus which comprises at least one processor and at least one memory, part of the memory including a computer program code wherein the at least one memory and the computer program code are configured, with the at least one processor, to cause the apparatus to perform any of the method steps described above.

As a further embodiment, a computer program product residing on a non-transitory computer readable medium is possible wherein the computer program comprises a program code for running a multitude of virtual machines as service chains on a given hardware, a program code to execute instances of a virtual machine which implement a complete service function chain, said service function chain comprising a multitude of service functions, further a program code for continuously measuring the processing load of each virtual machine which is executing a specific service function chain, together with a program code that controls the functionality that in case that the processing load of a certain virtual machine exceeds a predefined load level, an additional virtual machine that is able to execute the specific service function chain will be activated for executing the specific service function chain and program code that controls in case that the processing load of a certain virtual machine underruns a predefined load level, the work load of the specific service function chain of said virtual machine is transferred to another virtual machine that is able to execute the service function chain and in consequence the specific service function chain of said virtual machine is deactivated.

According to some embodiments of the invention, at least the following advantages are provided:
predictable performance;
easy load balancing;
easy and dynamic scaling;
Re-usage of VMs;
Less need for resource over-provisioning.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows two SFCs in a DC with load balancing according to the prior art;

FIG. 2 shows a SFC architecture according to IETF;

FIG. 3 shows a SFC configuration in a VM;

FIG. 4 shows a VM instantiation with SFCs;

FIG. 5 shows a structure of SF chain descriptors (upper box) and SF descriptors (lower box) (left side: generic design; right side: a specific example);

FIG. 6 shows an SFC instantiation process;

FIG. 7 shows a result of VNF chain VM reconfiguration;

FIG. 8 shows an apparatus according to an embodiment of the invention;

FIG. 9 shows a method according to an embodiment of the invention;

FIG. 10 shows an apparatus according to an embodiment of the invention;

FIG. 11 shows a method according to an embodiment of the invention;

FIG. 12 shows an apparatus according to an embodiment of the invention;

FIG. 13 shows a method according to an embodiment of the invention;

FIG. 14 shows an apparatus according to an embodiment of the invention;

FIG. 15 shows a method according to an embodiment of the invention; and

FIG. 16 shows an apparatus according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

From the considerations above there is some doubt that the one to one mapping of physical service functions of a chain or even its decomposed components to virtual SF in VMs is an optimal migration of service function chaining into the cloud.

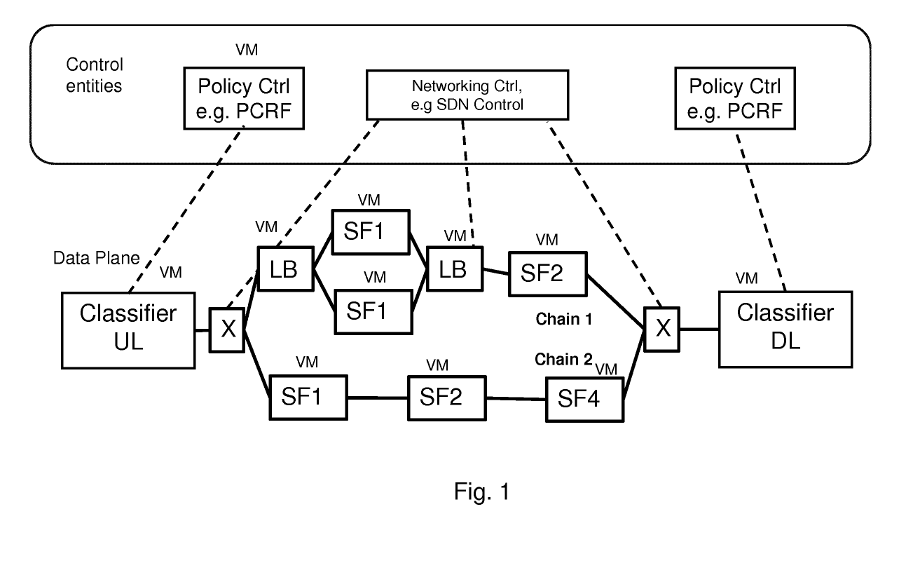

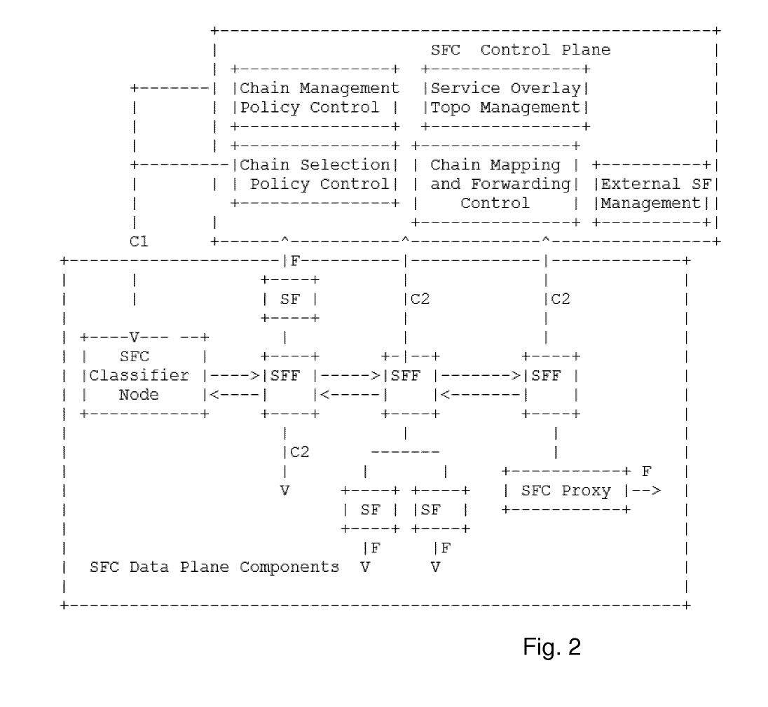

According to the architectures shown in FIGS. 1 and 2, different SF might be provided by different vendors and service function providers. An advantage to have each SF allocated in a single VM might be that there is a defined and stable runtime environment if all SF are isolated by an own OS-“container”. This allows also e.g. for a simpler testing.

However, the state of the art in SW processing is much more advanced: usually different applications from different vendors are running on the same OS. E.g., apps in mobile devices or dynamic link libraries are provided by different vendors and are combined in application programs. In the Windows OS, for example, the media stream processing of media players can use different components from different vendors for e.g. source filters, de-multiplexing, decoding and rendering that are combined during runtime.

According to some embodiments of the invention, each VM comprises SW of all the SFs making up a SFC which is intended to run on the VM. The VM may comprise SW of all the SFs for all SFCs that are intended to run of the VM. Plural VMs may be equipped with the same SW. For the deployment, a SW image may be used.

Advantages of this approach over the prior art are at least one of the following:
Predictable performance, especially for the latency of a service function chain (No need for complex topology or transport mechanisms considerations for achieving the required latency);
Much easier load balancing as not required for individual SFs but per chain; and
Easier and very dynamic scaling in and out—resource reuse (removing not used SF chains and deploying new SF chains on already existing VMs).

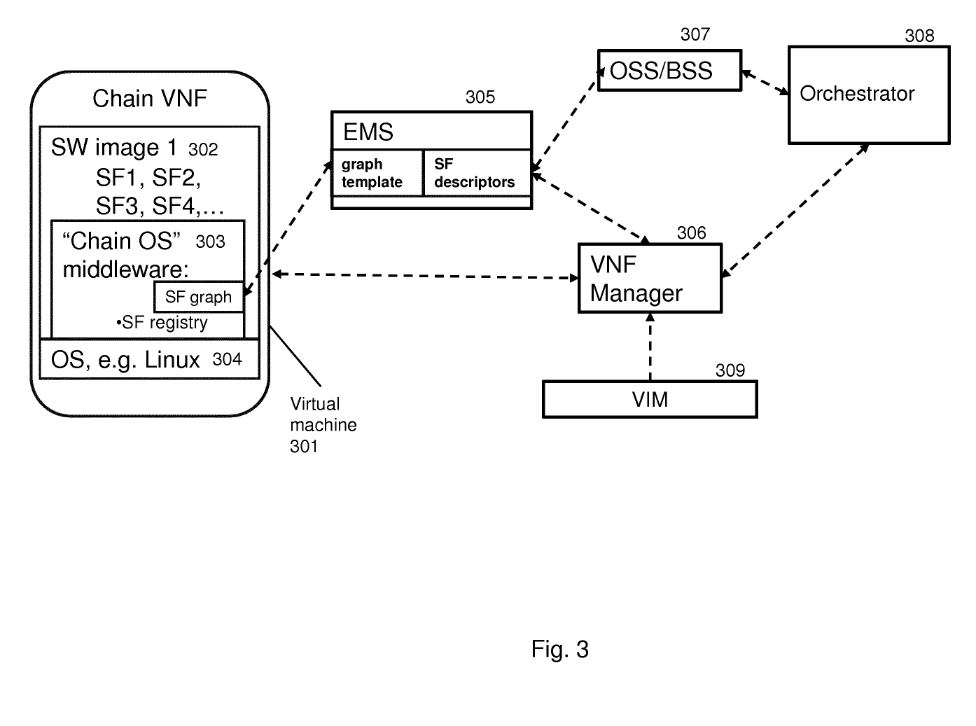

FIG. 3 illustrates SFC configuration in a VM. On a VM 301 acting as “Chain VNF” (a VNF on which one or more SFCs may run) is installed, on top of the OS 304, a SW image 302. The SW image 302 comprises all the SW needed for SFs of the SFC (denoted as SF1, SF2, SF3, SF4, . . . ). In addition, it comprises “Chain OS” middleware 303 deploying the SFC based on the SFs and its topology description depicted as “SF graph”. In detail, the “Chain OS” middleware comprises SF graph and SF registry.

The “Chain OS middleware” is controlled by a control entity. The control entity may be a part of EMS 305, a part of VNF Manager 306, a separate entity, or integrated with another functionality. Its function may be split distributed over plural entities such as distributed over EMS 305 and VNF manager 306. In FIG. 3, as an example, the control entity is integrated with EMS 305.

OSS/BSS 307, Orchestrator 308, and VIM 309 are shown for completeness and may fulfill their respective function as usual.

The control entity (e.g. EMS 305) in charge of configuring the one or more “Chain VNF” VMs contains among others two data tables:

One table that describes each chain (e.g. a graph template describing topology relationships between the SFs) including a chain representation that is to be downloaded to the Chain VNF VM to instantiate a specific chain, and a table of the SFs the chain(s) are build upon, wherein the table contains the SF descriptor/template.

The exact description of the SF chain that needs to be deployed on the VM is stored in the graph template. The graph template specifies how the SFs that compose the chain are connected. Such specification may be in the form of the list of composite SFs, but it is not limited to this kind of representation.

For managing the chain the SF descriptors/templates may additionally include further descriptions of the SF e.g. in the terms of load/computation requirements, assigned SF weight etc. Such additional information may be used during the VM instantiation and especially for VM reconfiguration from serving one chain to serving another chain. Depending on the number of users in the DC, different number of VMs may be initially instantiated for the individual SF chains with different requirements.

The interface for the chain management functions inside the Chain VNF resides within the entity called “Chain OS middleware” 303. Depending on the implementation, the control entity (e.g. VNF Manager 305 or EMS 306) or the Chain OS middleware or a functional distribution among them may provide following functions for managing the SF chains:

The SF may register itself to the control entity or the “Chain OS middleware” and provide input parameters about their supported interfaces. This could e.g. include support of packet header extensions according to some standard specification like IETF.

A SF graph may be configured that instantiates a particular SFC. The EMS or Chain OS may provide checks whether all SFs of the SFC can connect as required. The Chain OS may acknowledge the chain instantiation to external management entities such as the control entity, EMS or VNF Manager.

The Chain OS middleware may verify if all SFs needed for instantiation of a particular chain are already contained in the SW image of the VM. If this is not the case, it may inform the external management entities of missing SFs.

The Chain VNF (Chain OS middleware or other VNF internal management entity) may provide reports on the current SF Chain VM utilization to the EMS and VNF Manager. Such information is prerequisite for efficient dynamic scaling in/out of the VMs.

Some of the described functions may be part of the OS of the VM itself.

For each Chain VNF deploying one particular graph (related to a SFC with a Chain ID) the same dedicated load balancer will be assigned. All Chain VNFs, after successfully instantiating a graph, will register to the load balancer corresponding to that particular graph/Chain ID.

There are two options for implementing a SFC:

A static approach that the SW image contains already a runtime version of a SF chain. Everything (SFs and SFC(s) is already configured. This option might have more optimization potential for computational efficiency; or

A dynamic instantiation as shown in FIG. 3: After instantiation of a VM (say number “n” such as VM 301) with the “Chain VNF” SW (SW image 1 302), the control function (e.g. EMS 305 or VNF manager 306 or a separate entity) configures the SFC graph that activates a particular chain (e.g. with Chain ID x) in the VM 301. After this, the control entity programs the packet forwarding system of the DC to connect flow classifier and load balancer with corresponding VM(s) that serve Chain x. The load balancer will be updated with the instantiation of VM n.

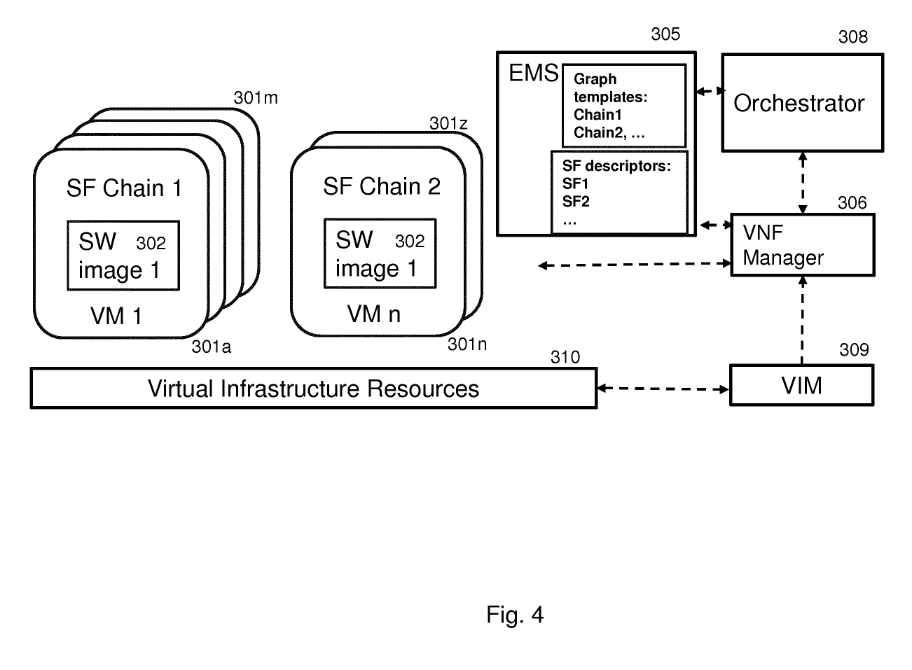

As a result of such a process, different number of VMs for different SF Chains may be instantiated depending on the load requirements as shown in the example of FIG. 4.

In FIG. 4 EMS 305, VNF Manager 306, Orchestrator 308, and VIM 309 correspond to those of the example shown in FIG. 3. Based on the virtual infrastructure resources 310 (managed by VIM 309), a number of VMs 301a, . . . , 301m, 301n, . . . , 301z is deployed. The number of VMs 301a, . . . , 301m and the number of VMs 301n, . . . , 301z are arbitrary. Each of these VMs 301a, . . . , 301z correspond to VM 301 of FIG. 3. On each of these VMs 301a, . . . , 301z, a same SW image (SW image 1 302) is installed. SW image 1 302 comprises SW for the SFs making up SFC1 and SFC2. Thus, each of VMs 301a, . . . , 301z may run either or both of SFC1 and SFC2. In addition, on each or some of the VMs 301a, . . . , 301z, additional SW, e.g. related to other SFs or other SFCs may be deployed (not shown).

In the example of FIG. 4, VMs 301a, . . . , 301m are configured, by the control entity (here: EMS 305), to run SFC1, and VMs 301n, . . . , 301z are configured to run SFC2.

The SF descriptors store the detailed information about each SF. This may include the detailed system requirements, priority, etc. The SF descriptors may contain the system requirements of the SF and optionally the additional parameters related to the exact SF implementation or operators' preferences.

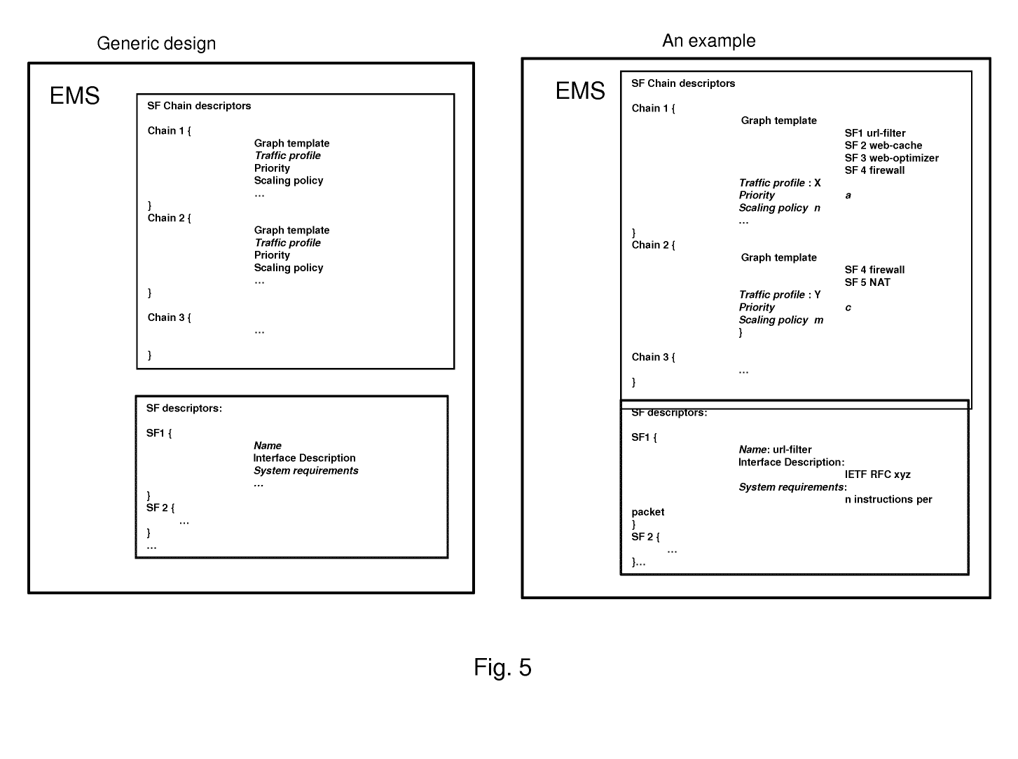

FIG. 5 illustrates an example of a data structure of SF Chains including the graph templates and the SF descriptors/templates. On the left side, a generic design of the data structure in the control entity (in FIG. 5: EMS as an example) is shown. On the right side, it is shown how the template of the left side is filled in according to a specific example. A corresponding representation is provided in the “Chain OS” middleware of each of the VMs.

The upper box comprises SF chain descriptors defining the service chain. In particular, it comprises the graph template. As may be seen on the right side of FIG. 5, the graph template indicates the sequence of SFs (e.g. SF1, SF2, SF3, SF4 for SFC1) making up the SFC. Some example SFs are indicated. In addition, the chain descriptor may comprise information on e.g. traffic policy, priority, scaling policy etc. There is a separate SF chain descriptor for each SFC.

The lower box on both sides of FIG. 5 comprises the SF descriptors. Each SF descriptor comprises a name of the SF and an interface description. In addition, it may comprise other information related to the SF such as system requirements. There is a SF descriptor for each of the SFs included in at least one of the SFCs described by the SF chain descriptors. However, if a SF is used by several SFCs (such as SF4 in the example on the right side, which is used by SFC1 and SFC2), there may be only one SF descriptor for this SF.

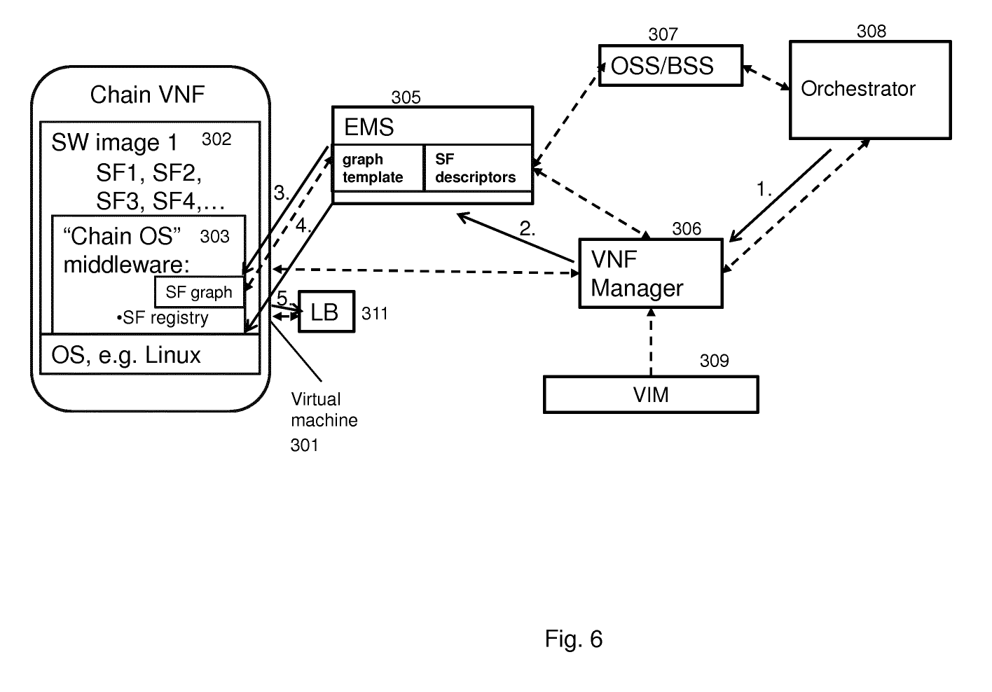

An example of an instantiation process is illustrated in FIG. 6. The entities shown in FIG. 6 correspond to those of FIG. 3.

The Orchestrator 308 allocates a certain portion of all available resources for instantiating the VMs that will deploy different SFCs, e.g. 100 VMs will be allocated for such a purpose according to input templates based on some network planning. In FIG. 6, only one (VM 301) of the plural (e.g. 100) VMs is shown.

The VNF Manager 306 informs the EMS 305 about the available running VMs that are dedicated for the instantiation of the SFCs.

The EMS 306 may take into consideration the expected traffic load and the characteristics of the SFCs, e.g. expected traffic profiles for each SFC in order to instantiate an appropriate number of different SFCs on each of the VMs and calculate the optimal work load distribution among them. E.g. the EMS 306 may decide that instantiation of chains on 100 activated VMs should follow the following schema: 40 VMs for SFC1, 30 VMs for SFC2, 10 VMs for SFC3, 10 VMs for SFC4, 10 VMs for SFC5. Thus, each of the VMs runs only one SFC. However, in other examples, some or all VMs may run plural SFCs.

The control entity (e.g. EMS or VNFM; in the example shown in FIG. 6, EMS acts as control entity) instantiates a respective load balancer for each SFC. In the example, 5 load balancers would be instantiated for the 5 SFCs, whereof only one (LB 311) is shown.

When a SFC is instantiated on the VM it can register to the corresponding load balancer. Thus, the load balancer may distribute packets for the respective SFC to the corresponding VMs.

According to the above configuration, the more efficient VM internal communication may be used between SFs of a SFC. This increases efficiency of SFC execution in the data plane. The overall number of VMs can be reduced due to higher resource efficiency if not each SF needs an own VM but only each SFC. This reduces also the virtualization overhead like the number of guest OS needed for the VNFs.

According to some embodiments of the invention, in DCs where SFCs with all their SFs are implemented on single VMs, the usage of the VMs may be adapted in a way such that the available resources are distributed among the SFC in an optimal way: during runtime VMs can be reconfigured in such a way that in one or more VMs with a load level under a certain threshold another chain can be activated for which a higher network throughput is required (e.g. because the currently allocated VMs for those SFC have a higher load level). Correspondingly, if a chain is underutilized in a VM (the LB of the chain selects this VM less often than a certain threshold), the VM may be reconfigured such that it does not run this chain any more, thus increasing capacity for other SFCs on the VM.

As criteria to determine whether a chain is underutilized in a VM, the load in the VM (in particular, if only the respective chain is running on that VM) may be used.

Alternatively, or in addition, the invocation frequency, i.e. how often the SFC on the VM is invoked, may be used. The invocation frequency may be measured at the VM or at the output side of the LB. If it is assumed that the LB distributes SFC invocation according to a specific rule, the invocation frequency of the SFC on a specific VM may also be determined from the total invocation frequency of the SFC (i.e. the demand for the SFC, which may be measured on the input side of the respective LB), and calculating the share of the specific VM under consideration. For example, if the rule of the LB is equal distribution on all VMs configured to run the SFC, the share is 1/(number of VMs configured to run the SFC).

These functions may be performed by the control entity (e.g. EMS for the SFC VNF, optionally in cooperation with the VNF manager for the SFC-VNF, see below).

This mechanism introduces an “inner loop” of control for optimal use of allocated resources/VMs for service function chaining in a given group of VMs for SF chaining. The term “inner loop” is used in contrast to “outer loop”, which denotes increasing or decreasing the overall number of VMs in the group for SF chaining, as according to the prior art. The operation of the “outer loop” is typically done by the orchestrator of the DC. The reconfiguration by the “outer loop” is a more heavy operation, i.e. it requires more CPU capacity and bandwidth, than the reconfiguration by the “inner loop”. Due to the “inner loop”, according to some embodiments of the invention, the “outer loop” needs to be done less often (or, in some cases, not at all).

With this “inner loop”, there is no need to instantiate new VMs as long as load can be distributed among already established VMs. The process can be performed much more dynamically than scaling the number of VMs (“outer loop”).

Advantages of the “inner loop” are at least one of the following:

Easier and very dynamic scaling in and out per chain;

Resources may be reused (by removing not used (underused) SF chains and deploying new SF chains on VMs already configured for service chaining);

Easier load balancing as load balancing may be performed per chain and need not be performed for individual SFs;

The number of VMs for SF chaining can be reduced as there is less need of resource over-provisioning.

Based on the information about SF chains and VMs utilization provided by the Chain VNF, the control entity (e.g. EMS and/or VNF Manager and/or a separate entity) may adjust the VM and SF chain allocation in the following way. The description assumes, as an example, a typical function split between the EMS and the VNF Manager as control entity. However, this function split is not restricting and any other conceivable function split between EMS, VNFM, and a separate control entity may be adopted.

The EMS in charge of configuring the “Chain VNF” VMs contains inter alia a load table containing the load status for all VMs configured to run an instance of a SF chain. The EMS collects the load information directly from the SFC-VMs (option 1) or indirectly from the VNF manager (option 2, VNFM may collect such information directly from the SFC-VMs or from the VIM). Based on internal policies (load thresholds, priorities of SF Chains, etc.) the EMS decides to reconfigure VMs. E.g., in order to meet the traffic demand, it may reconfigure a VM such that it is configured to run an instance of SFC-m instead of SFC-n. E.g., this may happen, if there is higher demand for some particular SF chains at the given time and on the other hand some VM running other chains are only little loaded. As other options, it my reconfigure the VM that it does not run a certain SFC any more, or that it is configured to run an instance of certain SFC in addition to instances of those SFCs it was already configured to run.

To provide a graceful migration, the EMS may inform the SFC VNF in advance about such operation. The SFC VM may then inform its load balancer to not assign new flows to this VM (especially if stateful functions are performed). Additionally, before final reconfiguration of the SFC-VM and shutting down the previously deployed SFC, the EMS may check in the load table of that SFC-VM if the VM is not longer loaded (all ongoing flows have been processed). In addition, it may check if the deployment of the new SFC is safe.

After the EMS has reconfigured the VM by downloading a new graph template, the VM may register itself by the new load balancer responsible for the new SF chain. Alternatively, EMS may inform the LB of the new SFC on the additional VM configured to run an instance of the new SFC.

In order to minimize the signaling required for regular updates of the load tables, alternatively (or in addition) a reduced reporting might be used. Instead of relying on regular reports on the load status of all VMs of a SF chain, the updates can be sent to the EMS only if some predefined thresholds are exceeded. Such thresholds may be predetermined or defined with respect to the used policies. For the efficient operation of the “inner control loop” two thresholds with respect to the SFC-VM load are of particular importance:

Max threshold—the upper limit for the SFC-VM load under which the operation and the load of the SFC-VM is considered to be normal. Once the load of the SFC goes above the “max threshold” the EMS should trigger the reconfiguration of one or more other VMs and deployment of an SFC running in the SFC-VM in the other VM(s).

Min threshold—the lower limit for the SFC-VM load under which the running of the separate VM for the SFC is not justified, i.e. the load of the SFC is so low that having a separate VM for such a load can be considered as a waste of resources. If the load of the SFC goes below the “min threshold”, that VM is a candidate for reconfiguration and deployment of another SFC for which more resources are needed e.g. SFC that reached the “max threshold”.

The EMS may determine the threshold values also depending on the number of VMs per SF Chain. Such threshold might be downloaded/configured in the SF Chain VNF by the EMS for reduced reporting. Therefore, the updates of the SFC-VM load tables on EMS can be triggered once the SFC-VM load goes beyond the “max threshold” or below “min threshold”. The EMS may take a time window or other history information into account. Based on internal policies (e.g. SFC priorities) the EMS can further take the actions to address the current traffic load and reconfigure the SFC-VMs accordingly.

The number of VMs and the type of the SF chains that are deployed on them may be dynamically adjusted based on e.g. the VMs utilization reports.

The need to reconfigure one or more VM may also be obtained from considering the demand for a certain SFC. This demand may be derived from the load on the respective load balancer. By dividing the demand by the number of VMs configured to run the respective SFC, the load on each of the VMs caused by this particular SFC may be estimated.

The control entity (e.g. EMS and/or VNF Manager) may also learn the typical traffic profiles and proactively react by allocating the VMs with deployed SF chains according to the expected traffic characteristics. E.g. if during the night there is higher demand for video optimizing SF chains the EMS reconfigure that particular SF chain on the higher number of already existing VMs.

Regardless of the way the SFC is instantiated on the Chain VNF, i.e. statically or dynamically as described hereinabove, there is a potential of resource optimization and efficient planning of the initial deployment of the SFCs based on the information stored in the graph templates and SF descriptors/templates contained in control entity (e.g. EMS) and in the descriptors for the orchestrator. In addition to the graph templates (providing the information about required connectivity between SFs), the SFC description can provide the information regarding traffic profile (e.g. time of the day with peak load for that chain etc.) or scaling policy and priority in case of handling resource shortages for a particular chain. Furthermore, based on the number of users in the DC, the traffic profile and system requirements of the individual SF of the chain the expected traffic load for each individual SFC may be estimated. All such additional information stored in the Chain template can serve as a valuable input for the resource planning during the SFC instantiation.

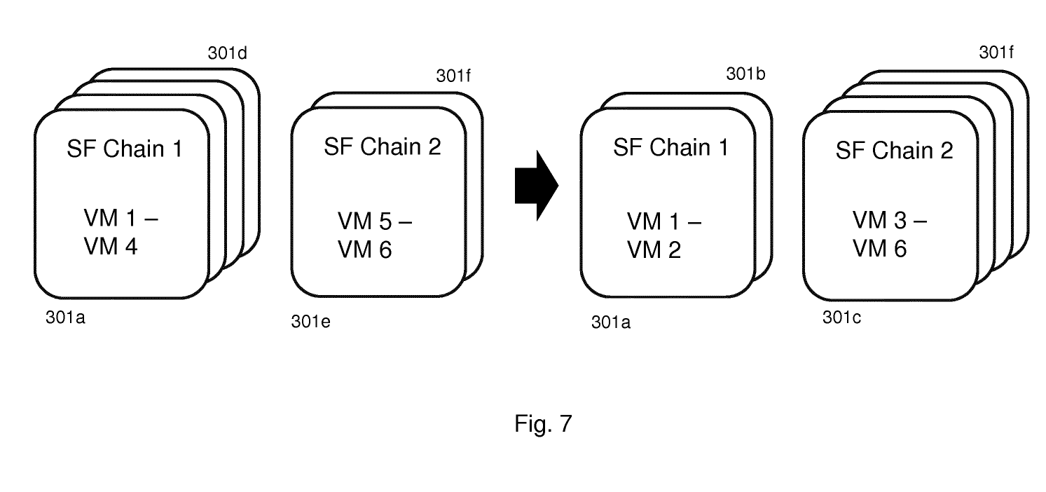

FIG. 7 shows a result of VNF chain VM reconfiguration. On the left side, before reconfiguration, 4 VMs 301a to 301d run SFC1, and 2 VMs 301e and 301f run SFC2. Note that each of these VMs corresponds to a VM of FIG. 4 with the same SW image installed thereon. After reconfiguration, as shown on the right side, 2 VMs 301a and 301b run SFC1, and 4 VMs 301c to 301f run SFC2. Thus, the capacity for SFC2 is increased at the cost of a reduced capacity for SFC1 but without increasing the number of VMs configured for service chaining.

According to some embodiments of the invention, the “outer control loop” may be still performed, in addition to the “inner control loop”:

By removing the VMs if the overall load level of the “SFC-VMs” are below a particular threshold. This is done via interworking of the VNF manager with the Orchestrator (removing resources) and EMS (inform the EMS about reduced number of VMs).

By adding new VMs. The EMS might deploy the SF Chains for which there is higher demand. Due to the reconfiguration described above all chains VM are to some extent equally loaded and the load has reached a particular threshold. This is done via standard scaling out operation of the VNF manager and interworking with the Orchestrator (allocating of resources) and EMS (informing about new VMs for SF chaining).

The “outer loop” is responsible for the resource allocation on the higher level (deploying the overall number of VMs that can be distributed differently among required SFCs), whereas the fine grained resource allocation and adjustments are done in the “inner loop” (reuse of existing resource) with the aim to avoid unnecessary triggering of the “outer loop”. However, in order to optimize the resource utilization the operation of the “inner control loop” and “outer control loop” may be tightly correlated. In other words, the inner loop may trigger the outer loop once some predefined conditions are met.

As an example of such conditions one may consider the following scenario. Once the EMS detects that X number of SFC-VMs have reached “min threshold” and Y number of SFC-VMs have reached “max threshold” where X is much lower than Y and that condition stays valid for more than Z time the outer loop should trigger the addition of new VMs. If the condition that X is much higher than Y is satisfied the “outer loop” should trigger the removal of VMs.

The conditions under which the “outer loop” is activated may depend on the available overall resources, defined policies, and desired level of orchestration actions. E.g. if releasing of VMs is not critical then the EMS can be instructed to trigger the scaling down outer loop only if very large number of VMs is free. Also if the actions from the Orchestrator needs to be minimized the scaling out will be triggered only if some very critical threshold is reached, otherwise the “inner loop” will try to reuse the resources as much as possible.

The EMS and VNF Manager can also learn the typical traffic profiles and proactively react by allocating the VMs with deployed SF chains according to the expected traffic characteristics. E.g if during the night there is higher demand for video optimizing SF chains the EMS reconfigure that particular SF chain on the higher number of already existing VMs.

As another option, the outer loop (e.g. the orchestrator) may observe how often the inner loop reconfigures VMs. If the reconfiguration frequency is relatively high, it may assume that the system is not stable because VM capacity is missing in the inner loop. In this case, according to some embodiments of the invention, the outer loop may increase the capacity for service chaining. E.g., the outer loop may add one or more VM for service chaining or increase the capacity of one or more VMs assigned to service chaining.

In order to monitor the reconfiguration frequency, the outer loop may either monitor the VMs or it may monitor the reconfiguration commands issued by the control entity of the inner loop.

As a result of such a process different number of VMs for different SF Chains may be instantiated depending on the load requirements. The number of VMs and the type of the SF chains that are deployed on them may be dynamically adjusted based on the SFC-VMs utilization reports.

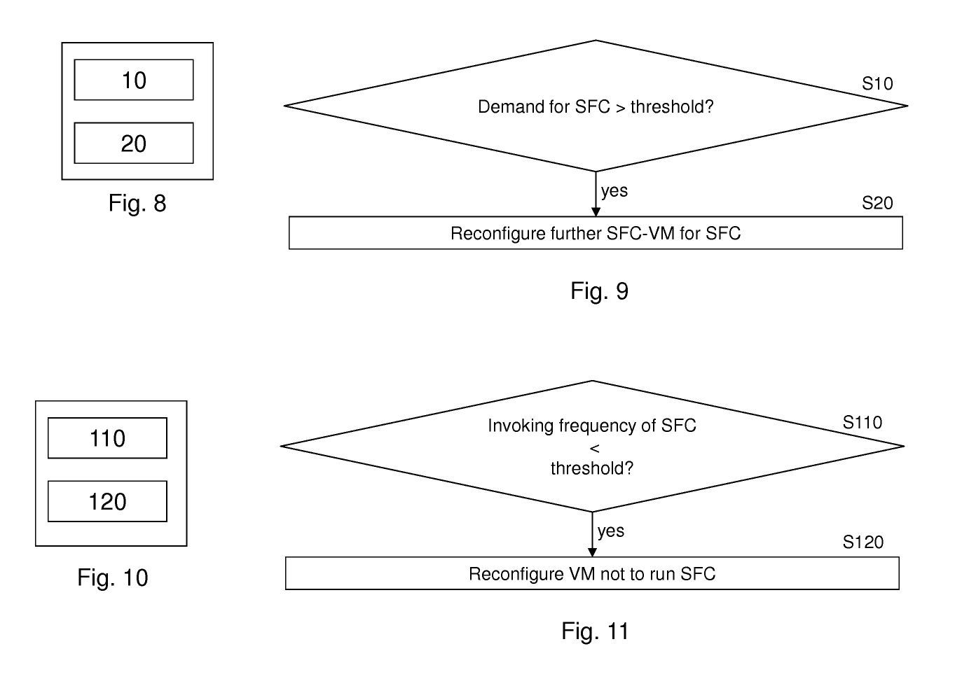

FIG. 8 shows an apparatus according to an embodiment of the invention. The apparatus may be a control apparatus such as a EMS or a VNF Manager or an element thereof. FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises demand detecting means 10 and reconfiguring means 20. The demand detecting means 10 and reconfiguring means 20 may be a demand detecting circuitry and reconfiguring circuitry, respectively.

The demand detecting means 10 detects if a demand for a service function chain exceeds a capacity of one or more virtual machines (S10). The capacity may be a capacity for the service function chain or a total capacity of the virtual machines. Each of the one or more virtual machines belongs to a group of virtual machines, wherein each of the virtual machines of the group is assigned to be configured to run a respective instance of the service function chain and respective instances of all service functions making up the service function chain; i.e., the VMs of the group are SFC-VMs.

If the demand exceeds the capacity (S10=“yes”), the reconfiguring means 20 reconfigures an additional virtual machine of the group to run a respective instance of the service function chain (S20). In addition, since each of the SFC-VMs is configured to run all SFs of a SFC, it reconfigures the VM to run respective instances of all the service functions making up the service function chain (S20). The additional virtual machine is different from each of the one or more virtual machines that were configured to run an instance of the SFC before the reconfiguration.

FIG. 10 shows an apparatus according to an embodiment of the invention. The apparatus may be a control apparatus such as a EMS or a VNF Manager or an element thereof. FIG. 11 shows a method according to an embodiment of the invention. The apparatus according to FIG. 10 may perform the method of FIG. 11 but is not limited to this method. The method of FIG. 11 may be performed by the apparatus of FIG. 10 but is not limited to being performed by this apparatus.

The apparatus comprises invoking frequency detecting means 110 and reconfiguring means 120. The invoking frequency detecting means 110 and reconfiguring means 120 may be an invoking frequency detecting circuitry and reconfiguring circuitry, respectively.

The invoking frequency detecting means 110 detects if an invoking frequency of invoking an instance of a service function chain in a virtual machine is below a lower invoking frequency threshold (S110). The virtual machine is a SFC-VM, i.e. the virtual machine is configured to run the instance of the service function chain and respective instances of all service functions making up the service function chain.

If the invoking frequency is below the lower invoking frequency threshold (S110=“yes”), the reconfiguring means 120 reconfigures the virtual machine such that it is not configured to run the instance of the service function chain any more (S120).

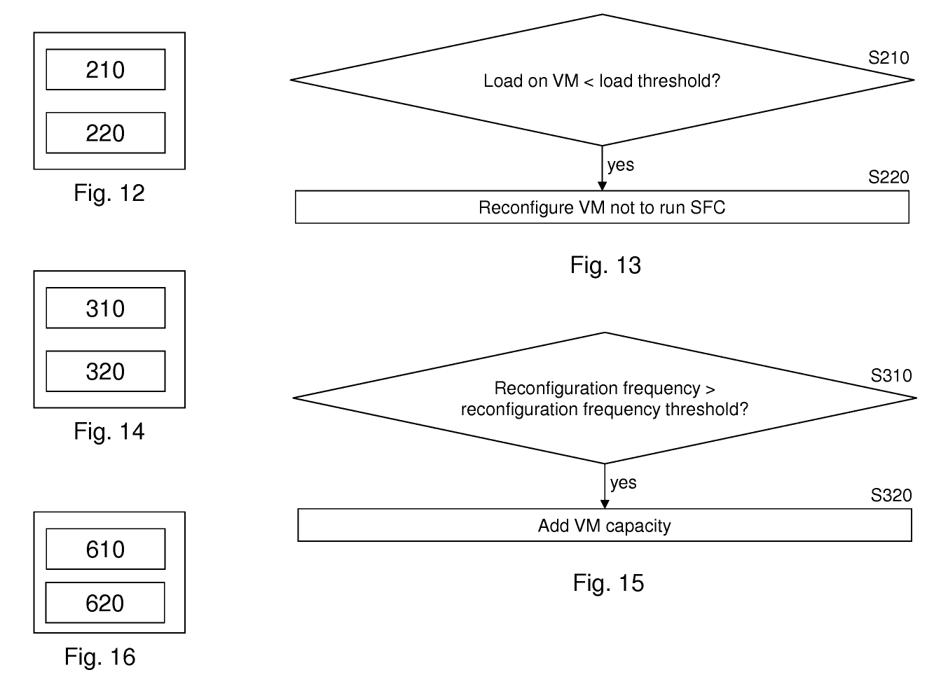

FIG. 12 shows an apparatus according to an embodiment of the invention. The apparatus may be a control apparatus such as a EMS or a VNF manager or an element thereof. FIG. 13 shows a method according to an embodiment of the invention. The apparatus according to FIG. 12 may perform the method of FIG. 13 but is not limited to this method. The method of FIG. 13 may be performed by the apparatus of FIG. 12 but is not limited to being performed by this apparatus.

The apparatus comprises load detecting means 210 and reconfiguring means 220. The load detecting means 210 and reconfiguring means 220 may be a load detecting circuitry and reconfiguring circuitry, respectively.

The load detecting means detects if a load in a virtual machine is below a lower load threshold (S210). The virtual machine is a SFC-VM, i.e. the virtual machine is configured to run the instance of the service function chain and respective instances of all service functions making up the service function chain. In some embodiments, the VM may be configured to run only one SFC at a time.

If the load is below the lower load threshold (S210=“yes”), the reconfiguring means 220 reconfigures, the virtual machine such that it is not configured to run the instance of the service function chain any more (S220).

FIG. 14 shows an apparatus according to an embodiment of the invention. The apparatus may be a control apparatus of the outer loop such as an orchestrator or an element thereof. FIG. 15 shows a method according to an embodiment of the invention. The apparatus according to FIG. 14 may perform the method of FIG. 15 but is not limited to this method. The method of FIG. 15 may be performed by the apparatus of FIG. 14 but is not limited to being performed by this apparatus.

The apparatus comprises reconfiguration monitoring means 310 and adding means 320. The reconfiguration monitoring means 310 and adding means 320 may be a reconfiguration monitoring circuitry and adding circuitry, respectively.

The reconfiguration monitoring means 310 monitors if one or more virtual machines are instructed to be reconfigured with a reconfiguration frequency higher than an upper reconfiguration frequency threshold (S310). Here, reconfiguring means a change of the configuration to run a set of service chains. I.e., reconfiguration includes at least one of configuring to run an instance of a first service function chain it has not been running when the reconfiguration instruction is received, and configuring not to run an instance of a second service function chain it has been running when the reconfiguration instruction is received. Each of the one or more virtual machines belongs to a group of virtual machines, wherein each of the virtual machines of the group is assigned to be configured to run a respective instance of group service function chains and respective instances of all service functions making up the respective service function chain. Each of the sets of service chains consists of one or more of the group service function chains.

The adding means 320 adds, if the reconfiguration frequency is higher than the upper reconfiguration threshold, virtual machine capacity to the group (e.g. by adding one or more VMs to the group and/or by increasing capacity of one or more VMs of the group) (S320).

FIG. 16 shows an apparatus according to an embodiment of the invention. The apparatus comprises at least one processor 610, at least one memory 620 including computer program code, and the at least one processor 610, with the at least one memory 620 and the computer program code, being arranged to cause the apparatus to at least perform at least one of the methods according to FIGS. 9, 11, 13, and 15 and related description.

Some embodiments of the invention may be employed in a 3GPP network. They may be employed also in other 3GPP and non-3GPP mobile and fixed networks such as CDMA, EDGE, LTE, LTE-A, UTRAN, WiFi, WLAN networks, PSTN, etc. That is, embodiments of the invention may be employed regardless of the access technology.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software.

According to the above description, it should thus be apparent that example embodiments of the present invention provide, for example a control apparatus such as a EMS or a VNF Manager, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques, means, devices, or methods include, as non-limiting examples, implementations as hardware, software, firmware, special purpose circuits or logic, general purpose hardware or controller or other computing devices, a virtual machine, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

It will be obvious to a person skilled in the art that, as the technology advances, the inventive concept can be implemented in various ways. The invention and its embodiments are not limited to the examples described above but may vary within the scope of the claims.

### ABBREVIATIONS

3GPP 3rd Generation Partnership Project

5 G 5^{th} Generation

API Application Program Interface

BSS Business Support System

CPU Central Processing Unit

Ctrl Control

DC Data Centre

DL downlink

DPDK Intel Data Plane Development Kit

EDGE Enhanced Datarate for GSM Evolution

EMS Element Management System

EPC Evolved Packet Core

ETSI European Telecommunications Standards Institute

GPRS Generic Packet Radio Service

GSM Global System for Mobile Communication

ID Identifier

IETF Internet Engineering Task Force

IP Internet Protocol

IT Information Technology

LB Load Balancer

LTE Long Term Evolution

LTE-A LTE Advanced

NAT Network Address Translation

NFV Network Function Virtualization

NFVI NFV Infrastructure

NORMA NOvel Radio Multiservice adaptive network Architecture

OS Operating System

OSS Operation Support System

PCRF Policy and Charging Rules Function

PSTN Public Switched Telephone Network

Rel Release

SDN Software-defined networking

SF Service Function

SFC Service Function Chaining

SFF Service Forwarder Function

SR-IOV Single Root I/O Virtualization

SW Software

TCO Total Cost of Ownership

TCP Transmission Control Protocol

TS Technical Specification

UE User Equipment, mobile device

UL uplink

UMTS Universal Mobile Telecommunications System

URL Uniform Resource Locator

VIM Virtual Infrastructure Manager

VM Virtual Machine

VNF Virtualized Network Function

vNIC Virtual Network Interface Card

VoIP Voice over IP

WiFi Wireless Fidelity

WLAN Wireless Local Area Network

1-15. (canceled)

16. A method for adaptive service function chain configuration, the method comprising:
executing a multitude of virtual machines on a given hardware device, and executing with a single instance of a virtual machine a complete service function chain, the service function chain containing a multitude of service functions;
continuously measuring a processing load of each virtual machine that is executing a specific service function chain; and
in case that the processing load of a given virtual machine exceeds a predefined load level, activating an additional virtual machine that is able to execute the specific service function chain to execute the specific service function chain;
in case that the processing load of a given virtual machine underruns a predefined load level, transferring the work load of the specific service function chain of the given virtual machine to another virtual machine that is able to execute the service function chain, and deactivating the specific service function chain of the given virtual machine.

17. The method according to claim 16, which comprises using the given virtual machine whose service function chain execution has been deactivated to execute service functions of a virtual machine that exceeds a predefined load level.

18. The method according to claim 16, wherein necessary software components to execute arbitrary service chain functionality are loaded into all virtual machines.

19. The method according to claim 18, which comprises using a service function chain resource manager to control an activation or deactivation of service function chains in the virtual machines.

20. The method according to claim 19, wherein a subset of software components are loaded into a virtual machine and the loaded subset of software components is sufficient to execute one or a plurality of service chain functionalities.

21. The method according to claim 16, wherein the service function chain of any instance of a virtual machine is configured according to a service function chain descriptor.

22. The method according to claim 16, which comprises using the virtual machine executing a service function chain itself for measuring the processing load or measuring the processing load with an underlying infrastructure (HW or the operating system) and regularly transferring the information to an infrastructure manager and the service function chain resource manager.

23. The method according to claim 22, wherein the processing load is defined by relevant parameters selected from the group consisting of a processor load, a memory space, a free memory and other parameters suited for load measuring or any combination of load measuring parameters.

24. An apparatus, configured
to run a multitude of virtual machines as service chains on a given hardware, with a single instance of a virtual machine is executing a complete service function chain, and the service function chain containing a multitude of service functions;
to continuously measure a processing load of each virtual machine which is executing a specific service function chain; and
in case that the processing load of a given virtual machine exceeds a predefined load level, to activate an additional virtual machine capable of executing the specific service function chain and to execute the specific service function chain; and
in case that the processing load of a given virtual machine underruns a predefined load level, to transfer the work load of the specific service function chain of the given virtual machine to another virtual machine that is able to execute the service function chain and to deactivate the specific service function chain of the given virtual machine.

25. The apparatus according to claim 24, further configured in such a way, that if a former active service chain execution of a virtual machine has been deactivated, said virtual machine is able to take over the service function chain execution of another virtual machine, which has exceeded a predefined load level.

26. The apparatus according to claim 25, further configured to load necessary software components for arbitrary service chain functionality into all virtual machines and to execute the software components.

27. The apparatus according to claim 26, further configured to additionally execute service function chain resource manager software that is able to activate or deactivate service function chains in virtual machines.

28. The apparatus according to claim 25, further configured to load a subset of software components into a virtual machine and wherein the loaded subset of software components is configured to execute a plurality of service chain functionalities.

29. The apparatus according to claim 24, wherein the virtual machine which executes as service function chain comprises additional software components which enable the service function chain itself to measure a processing load or collect the information from underlying hardware or operating system on a regular basis.

30. A computer program, embodied on a non-transitory computer readable medium, the computer program comprising:
code for running a multitude of virtual machines as service chains on given hardware;
code for executing instances of a virtual machine which implement a complete service function chain, the service function chain containing a multitude of service functions;
code for continuously measuring a processing load of each virtual machine that is executing a specific service function chain;
code configured to cause, in case the processing load of a certain virtual machine exceeds a predefined load level, an additional virtual machine that is able to execute the specific service function chain to be activated for executing the specific service function chain; and
code configured to cause, in case the processing load of a certain virtual machine underruns a predefined load level, the work load of the specific service function chain of the virtual machine to be transferred to another virtual machine that is able to execute the service function chain and in consequence to deactivate the specific service function chain of the virtual machine.
